(19) United States
(12) Patent Application Publication
(10) Pub. No.: US 2026/0285438 A1
(43) Pub. Date: Sep. 24, 2026

(54) BICYCLE HANDLEBAR ASSEMBLY

(71) Applicant: SIENNA GROUP CORPORATION, Taichung City (TW)

(72) Inventors: Chung-Pin Hsiao, Taichung City (TW); Ching-Tan Lin, Taichung City (TW)

(73) Assignee: SIENNA GROUP CORPORATION, Taichung City (TW)

(21) Appl. No.: 19/576,318

(22) Filed: Mar. 24, 2026

(30) Foreign Application Priority Data
Mar. 24, 2025 (TW) 114111007

(51) Int. Cl. B62K 21/12; B62K 21/16

(52) U.S. Cl. CPC B62K 21/125; B62K 21/16

(57) ABSTRACT

A bicycle handlebar assembly includes a handlebar, two bases, two brackets, and two auxiliary handlebars. The handlebar has two positioning seats located close to the left and right sides of the center of the handlebar. The top of the base has an arc-shaped concave portion. The bracket has an adjustment seat. The underside of the adjustment seat has an arc-shaped convex portion. The lower section of the adjustment seat has two elongate grooves. The adjustment seat has two accommodating holes for accommodating two locking pins each having a locking hole. By alternately tightening and loosening two angle adjustment bolts that are inserted from the bottom end of the positioning seat through the base into the elongate grooves to act on the two locking pins in the adjustment seat, the bracket is driven to change angle, which in turn adjusts the angle of the auxiliary handlebar attached to the bracket.

### FIELD OF THE INVENTION

The present invention relates to bicycle accessories, and more particularly, to a bicycle handlebar assembly.

### BACKGROUND OF THE INVENTION

When a bicycle is used for racing, a pair of auxiliary handlebars is typically mounted on the handlebar, with an extension seat installed on each auxiliary handlebar. An armrest is secured to the extension seat, allowing the rider to adjust their riding posture using the auxiliary handlebars. For example, the armrest provides temporary support for the forearms, thereby enhancing riding comfort.

As disclosed in Taiwan Utility Model Registration No. M554441, titled “ANGLE-ADJUSTABLE STRUCTURE OF BICYCLE AUXILIARY HANDLEBAR”, as claimed in claim 11 and shown in FIG. 21 through FIG. 25 thereof, it comprises a pair of auxiliary handlebars and a pair of retaining seats corresponding to the auxiliary handlebars. One end of the auxiliary handlebar is detachably secured to an extension seat. An overhang extends from one side of the extension seat. The overhang has a through hole. The retaining seats are secured to both sides of one end of the bicycle stem. The retaining seat has a central hole extending horizontally. The top of the retaining seat has an elongated mounting hole communicating with the central hole. A locking pin is mounted in the central hole. The overhang of the extension seat abuts against the top of the retaining seat. A bolt is aligned with the through hole and the mounting hole and inserted into the retaining seat to tighten the locking pin for controlling the overhang to be pressed against or released from the retaining seat. When the bolt is unscrewed, the auxiliary handlebar, along with the extension seat and the locking pin, is pulled and moved within the range of the mounting hole to adjust the angle of the auxiliary handlebar up and down.

Although the aforementioned structure allows the angle of the auxiliary handlebar to be adjusted up and down, the extension seat used to secure one end of the auxiliary handlebar must be equipped with an armrest for the cyclist's arm to rest against it during riding. Therefore, the cyclist's arm will exert a downward force on the extension seat while riding. The structure that assists in adjusting the angle of the auxiliary handlebar is achieved through an overhang extending from one side of the extension seat. The overhang has a through hole, in cooperation with a pair of retaining seats corresponding to the auxiliary handlebars. The retaining seats are secured to both sides of one end of the bicycle stem. The retaining seat has a central hole extending horizontally. The top of the retaining seat has an elongated mounting hole communicating with the central hole. A locking pin is mounted in the central hole. The overhang of the extension seat abuts against the top of the retaining seat. A bolt is aligned with the through hole and the mounting hole and inserted into the retaining seat to tighten the locking pin for controlling the overhang to be pressed against or released from the retaining seat. When the bolt is unscrewed, the auxiliary handlebar, along with the extension seat and the locking pin, is pulled and moved within the range of the mounting hole to adjust the angle of the auxiliary handlebar up and down. Therefore, when a cyclist rests his/her arm on the armrest while riding, a downward force is applied to the armrest located on one side of the extension seat, forming a cantilever-type downward force, which is jointly borne by the extension seat together with the auxiliary handlebar. The overhang abuts against the top of the retaining seat, and the bolt is aligned with the through hole of the overhang and the mounting hole and inserted into the retaining seat to tighten the locking pin for controlling the overhang to be pressed against or released from the retaining seat. When the bolt is unscrewed, the auxiliary handlebar, along with the extension seat and the locking pin, is pulled and moved within the range of the mounting hole to adjust the angle of the auxiliary handlebar up and down. During riding, the bolt will have to bear the full force exerted by the arm pressed down in a cantilevered manner on the armrest on the other side of the extension seat. This may cause the overhang to bend along the radial direction of the auxiliary handlebar, and even result in wobbling between the through hole of the overhang and the bolt, thus making it impossible to effectively adjust the angle of the entire auxiliary handlebar. Accordingly, the inventor of the present invention has devoted himself based on his many years of practical experiences to solve these problems.

### SUMMARY OF THE INVENTION

The primary object of the present invention is to provide a bicycle handlebar assembly.

In order to achieve the foregoing object, the bicycle handlebar assembly provided by the present invention comprises a handlebar, two bases, two brackets, and two auxiliary handlebars. The handlebar has two positioning seats located close to left and right sides of a center of the handlebar. Each of the positioning seats has two apertures arranged in tandem. The two bases are mounted on top of the respective positioning seats of the handlebar. Each of the bases has two through holes arranged in tandem and corresponding in position to the apertures of corresponding the positioning seat and an arc-shaped concave portion with a constant curvature on a top thereof. The two brackets each include a sleeve section, an extension seat, and an adjustment seat. The sleeve section has a receiving hole extending axially. The extension seat extends from an outer side of the sleeve section. An armrest is disposed on a top of the extension seat. The adjustment seat extends downward and is located between the sleeve section and the extension seat. An underside of the adjustment seat has an arc-shaped convex portion with a constant curvature to mate with the arc-shaped concave portion of the top of the base. A lower section of the adjustment seat has two elongate grooves arranged in tandem and corresponding in position to the two through holes of the base. One side of the adjustment seat has two accommodating holes communicating with the respective elongate grooves for accommodating two locking pins each having a locking hole. Two angle adjustment bolts are inserted from bottom ends of the apertures of the corresponding positioning seat of the handlebar through the through holes of the corresponding base into the elongate grooves in the adjustment seat of the corresponding bracket and locked with the locking holes of the two locking pins. The two auxiliary handlebars each have a rear end and a front end extending upward at an angle. The rear end passes through the receiving hole of the sleeve section of the corresponding bracket and is secured to the corresponding bracket. By alternately tightening and loosening the two angle adjustment bolts to act on the two locking pins in the adjustment seat of the bracket, the bracket is driven to change angle, which in turn adjusts the angle of the auxiliary handlebar attached to the bracket.

Preferably, the top of the base has the arc-shaped concave portion with a constant curvature. The underside of the adjustment seat of the bracket has the arc-shaped convex portion with a constant curvature. The extension seat of the bracket extends outward and rearward from the outer side of the sleeve section. The two auxiliary handlebars are secured to the two brackets, respectively. When the brackets are to be combined with the bases, the bracket which is originally located close to the left side of the center of the handlebar is rotated 180 degrees clockwise to mate with the base which is originally located close to the right side of the center of the handlebar, and the bracket which is originally located close to the right side of the center of the handlebar is rotated 180 degrees counterclockwise to mate with the base which is originally located close to the left side of the center of the handlebar. Finally, the two angle adjustment bolts are inserted from the bottom ends of the apertures of the positioning seat on the handlebar through the through holes of the base into the elongate grooves in the adjustment seat of the bracket and locked with the locking holes of the two locking pins, such that the bracket and the base is mounted to the positioning seat of the handlebar. Even when the two brackets are rotated 180 degrees clockwise and counterclockwise respectively and swapped left and right, the armrests can still be locked onto the tops of the extension seats of the brackets, and the auxiliary handlebars are secured to the brackets, respectively. By alternately tightening and loosening the two angle adjustment bolts to act on the two locking pins in the adjustment seat of the bracket, the bracket is driven to change angle, which in turn adjusts the angle of the auxiliary handlebar attached to the bracket.

Preferably, even when the two brackets are rotated 180 degrees clockwise and counterclockwise respectively and swapped left and right, the armrests can still be locked onto the tops of the extension seats of the brackets, and the auxiliary handlebars are secured to the respective brackets. When the armrest on the top of the extension seat is moved and adjusted forward and rearward, the distance by which the armrest is adjusted toward the front end of the auxiliary handlebar can be increased by an additional distance, thereby allowing the armrest to be positioned closer to the front end of the auxiliary handlebar. Similarly, the distance from the rear end of the auxiliary handlebar to the front end, measured with the rear end of the base secured to the handlebar as the reference point, can be increased by an additional distance. Accordingly, the bicycle handlebar assembly provided by the present invention allows cyclists to adjust the distance between the armrest and the front end of the auxiliary handlebar based on the length of their arms and their preferred way of resting their arms on the armrests.

### BRIEF DESCRIPTION OF THE DRAWINGS

FIG. 1 is an exploded view according to a first embodiment of the present invention;

FIG. 2 is a bottom perspective view of the bracket in FIG. 1;

FIG. 3 is a partial sectional, exploded view according to the first embodiment of the present invention;

FIG. 4 is another exploded view according to the first embodiment of the present invention, view from the bottom;

FIG. 5 is a partial perspective view according to the first embodiment of the present invention;

FIG. 6 is a perspective view according to the first embodiment of the present invention;

FIG. 7 is a left side schematic view according to the first embodiment of the present invention, wherein the rear end of the auxiliary handlebar is in a horizontal state;

FIG. 8 is a left side sectional view according to the first embodiment of the present invention, wherein the rear end of the auxiliary handlebar is in a horizontal state;

FIG. 9 is a left side schematic view according to the first embodiment of the present invention, wherein the auxiliary handlebar is adjusted to tilt upward;

FIG. 10 is a left side sectional view according to the first embodiment of the present invention, wherein the auxiliary handlebar is adjusted to tilt upward;

FIG. 11 is a partial perspective view according to a second embodiment of the present invention;

FIG. 12 is a perspective view according to the second embodiment of the present invention;

FIG. 13 is a left side schematic view according to the second embodiment of the present invention, wherein the rear end of the auxiliary handlebar is in a horizontal state;

FIG. 14 is a left side sectional view according to the second embodiment of the present invention, wherein the rear end of the auxiliary handlebar is in a horizontal state;

FIG. 15 is a left side schematic view according to the second embodiment of the present invention, wherein the auxiliary handlebar is adjusted to tilt upward;

FIG. 16 is a left side sectional view according to the second embodiment of the present invention, wherein the auxiliary handlebar is adjusted to tilt upward; and

FIG. 17 is a comparative diagram of FIG. 7 and FIG. 13.

### DETAILED DESCRIPTION OF THE PREFERRED EMBODIMENTS

Embodiments of the present invention will now be described, by way of example only, with reference to the accompanying drawings.

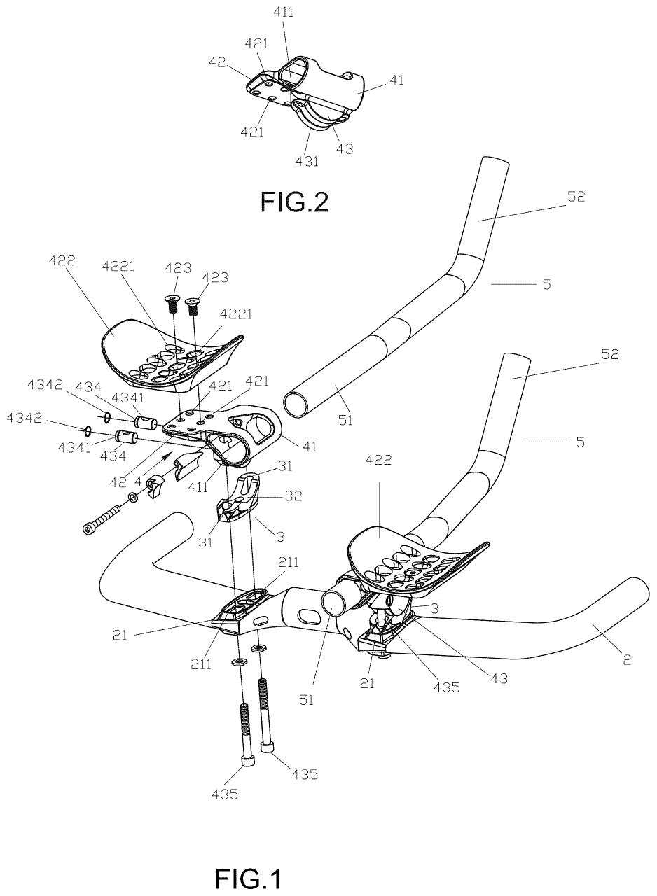

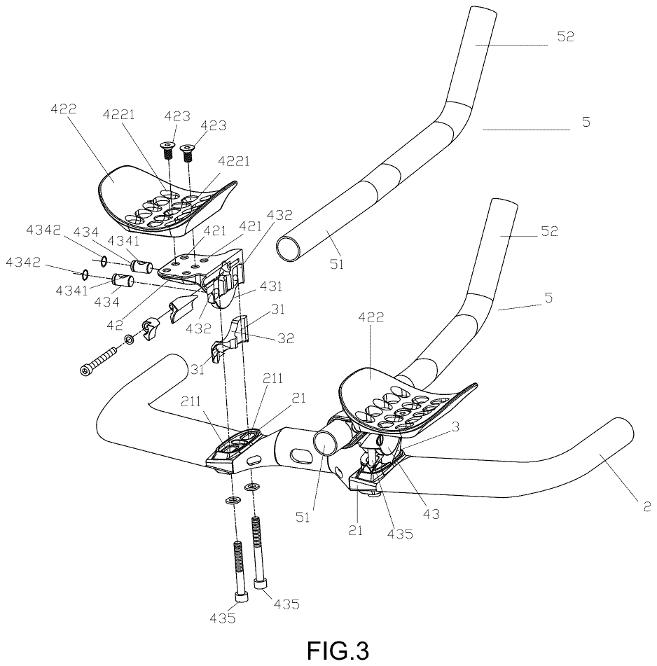

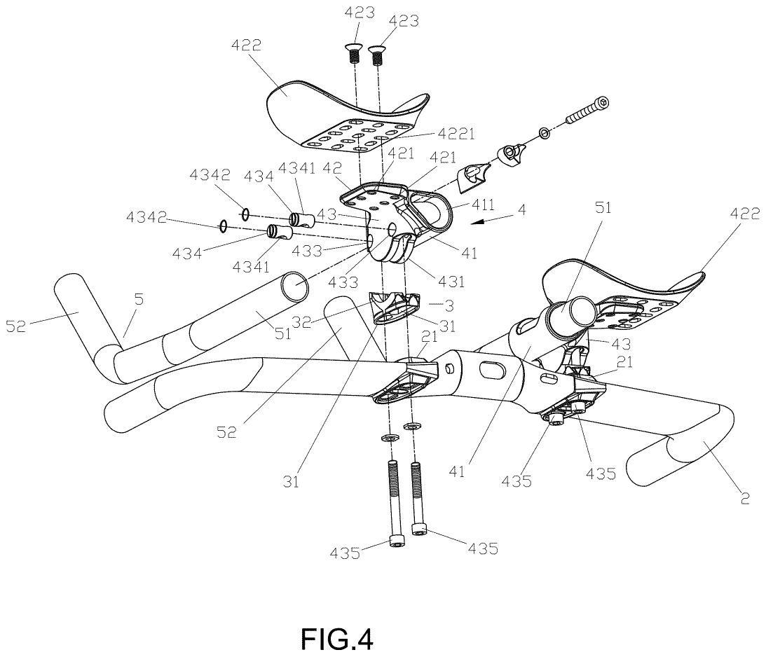

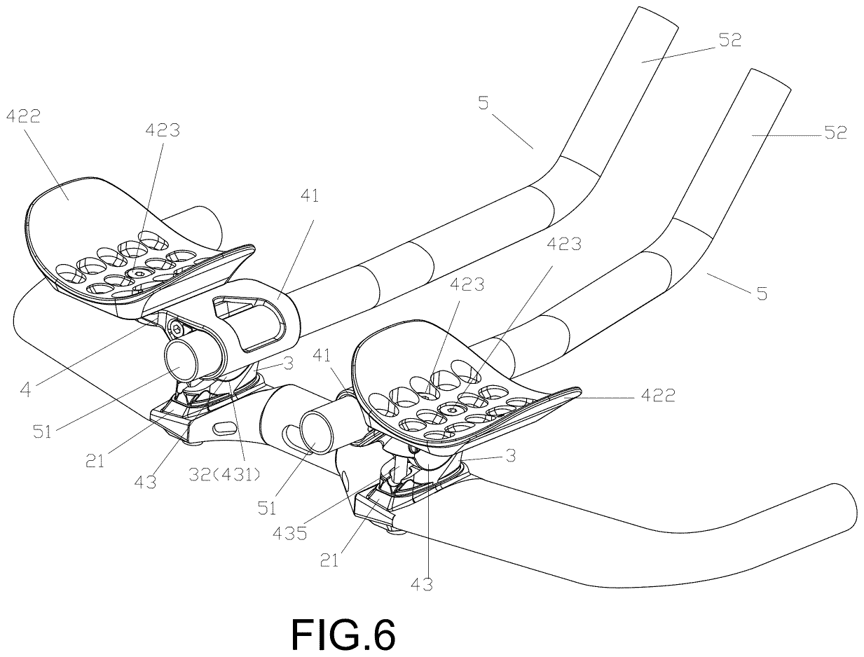

As shown in FIG. 1 through FIG. 10, a bicycle handlebar assembly according to a first embodiment of the present invention comprises a handlebar 2, two bases 3, two brackets 4, and two auxiliary handlebars 5.

The handlebar 2 has two positioning seats 21 located close to left and right sides of the center of the handlebar 2. Each positioning seat 21 has two apertures 211 arranged in tandem to serve as adjustment space.

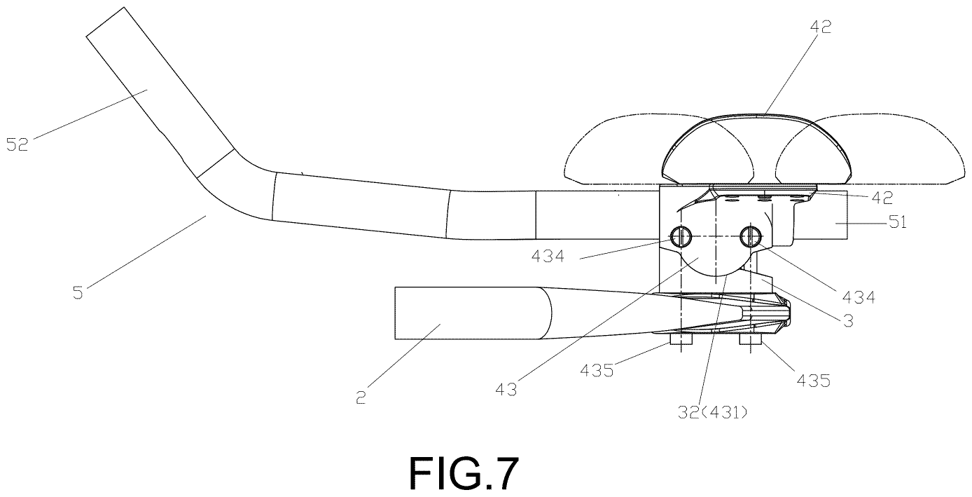

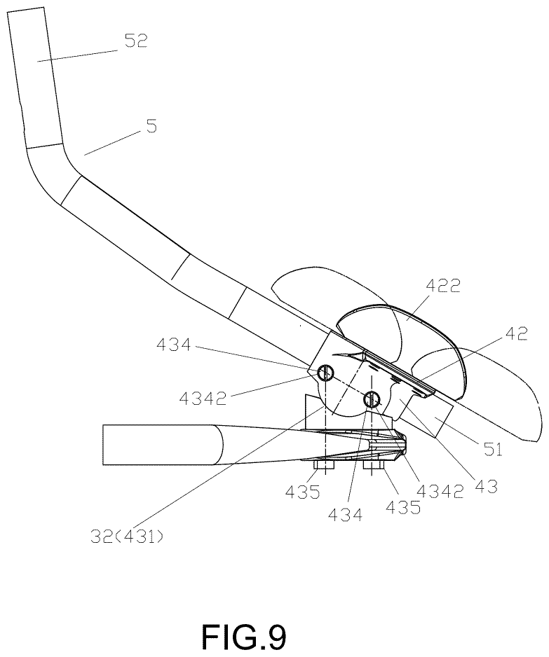

The two bases 3 are mounted on top of the respective positioning seats 21 of the handlebar 2. The base 3 is generally trapezoidal in shape, as shown in FIG. 7 and FIG. 9, and has two through holes 31 arranged in tandem and corresponding in position to the apertures 211 of the positioning seat 2 to serve as adjustment space. The top of the base 3 has an arc-shaped concave portion 32 with a constant curvature.

The bracket 4 includes a sleeve section 41, an extension seat 42, and an adjustment seat 43. The sleeve section 41 has a receiving hole 411 extending axially. The extension seat 42 extends outward and rearward from the outer side of the sleeve section 41. The extension seat 42 has a plurality of mounting holes 421 arranged in parallel. An armrest 422 is disposed on the top of the extension seat 42. The armrest 422 has a plurality of coupling holes 4221 arranged in parallel. The coupling holes 4221 of the armrest 422 correspond to the mounting holes 421 of the extension seat 42. The armrest 422 is secured to the top of the extension seat 42 by bolts 423 passing through the coupling holes 4221 and the mounting holes 421. By aligning the coupling holes 4221 of the armrest 422 with the mounting holes 421 of the extension seat 42 at different positions, the armrest 422 can be moved and adjusted forward and rearward as well as left and right on the top of the extension seat 42 and locked by the bolts 423. The adjustment seat 43 extends downward and is located between the sleeve section 41 and the extension seat 42. The underside of the adjustment seat 43 has an arc-shaped convex portion 431 with a constant curvature to mate with the arc-shaped concave portion 32 of the top of the base 3. The lower section of the adjustment seat 43 has two elongate grooves 432 arranged in tandem and corresponding in position to the two through holes 31 of the base 3. One side of the adjustment seat 43 has two accommodating holes 433 communicating with the respective elongate grooves 432 for accommodating two locking pins 434 each having a locking hole 4341. Each of the locking pins 434 is sleeved with an elastic washer 434 located around the periphery of the corresponding accommodating hole 433. Finally, two angle adjustment bolts 435 are inserted from the bottom ends of the apertures 211 of the positioning seat 21 of the handlebar 2 through the through holes 31 of the corresponding base 3 into the elongate grooves 432 in the adjustment seat 43 of the corresponding bracket 4 and locked with the locking holes 4341 of the two locking pins 434.

The auxiliary handlebar 5 has a rear end 51 and a front end 52 extending upward at an angle. The rear end 51 passes through the receiving hole 411 of the sleeve section 41 of the bracket 4 and is secured to the bracket 4. The front end 52 provides a handhold for the rider.

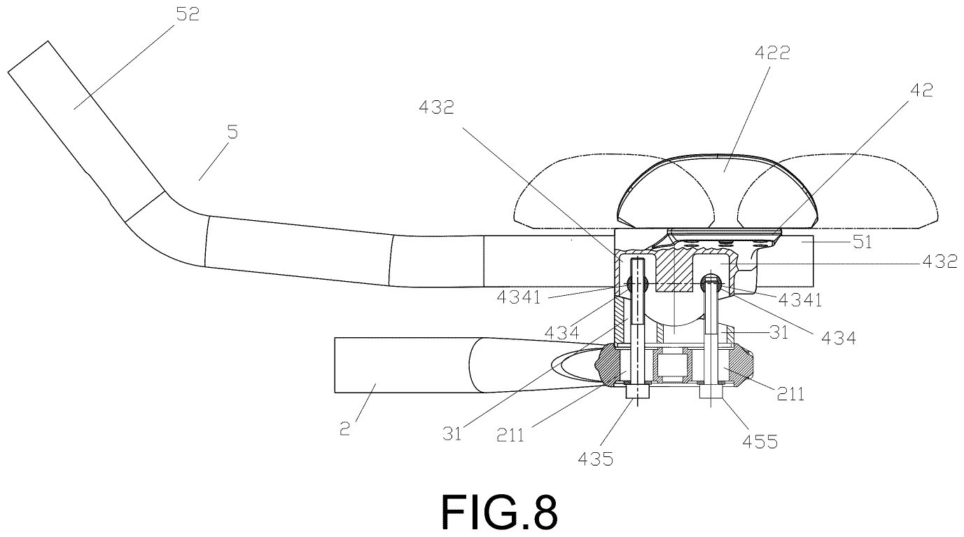

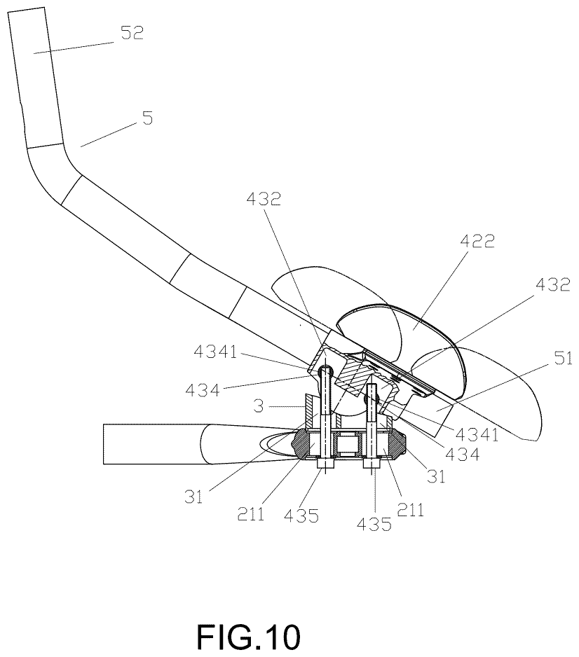

Through the aforementioned structural configuration, the auxiliary handlebar 5 can be adjusted in angle. Please refer to FIG. 7 and FIG. 8. Taking the auxiliary handlebar 5 initially assembled in a horizontal state as an example, the two angle adjustment bolts 435 are parallel to each other, in cooperation with the two locking pins 434 that are embedded and positioned in the two accommodating holes 433 of the adjustment seat 43. When the locking holes 4341 of the two locking pins 434 are engaged with the two angle adjustment bolts 435, the two locking pins 434 are in a horizontal state. As shown in FIG. 9 and FIG. 10, for the auxiliary handlebar 5 to be adjusted to tilt upward, the rear angle adjustment bolt 435 is further screwed and tightened along the locking hole 4341 of the rear locking pin 434, and the front angle adjustment bolt 435 is unscrewed and loosened. Thus, one of the locking pins 434 is moved upward and the other one of the locking pins 434 is moved downward, driving the bracket 4 to tilt upward and allowing the auxiliary handlebar 5 attached to the bracket 4 to be adjusted to tilt upward. For the auxiliary handlebar 5 to be adjusted to tilt downward, the rear angle adjustment bolt 435 is unscrewed and loosened along the locking hole 4341 of the rear locking pin 434, and the front angle adjustment bolt 435 is further screwed and tightened. Thus, one of the locking pins 434 is moved upward and the other one of the locking pins 434 is moved downward, driving the bracket 4 to tilt downward and allowing the auxiliary handlebar 5 attached to the bracket 4 to be adjusted to tilt downward. In this way, the auxiliary handlebar 5 can be adjusted in angle.

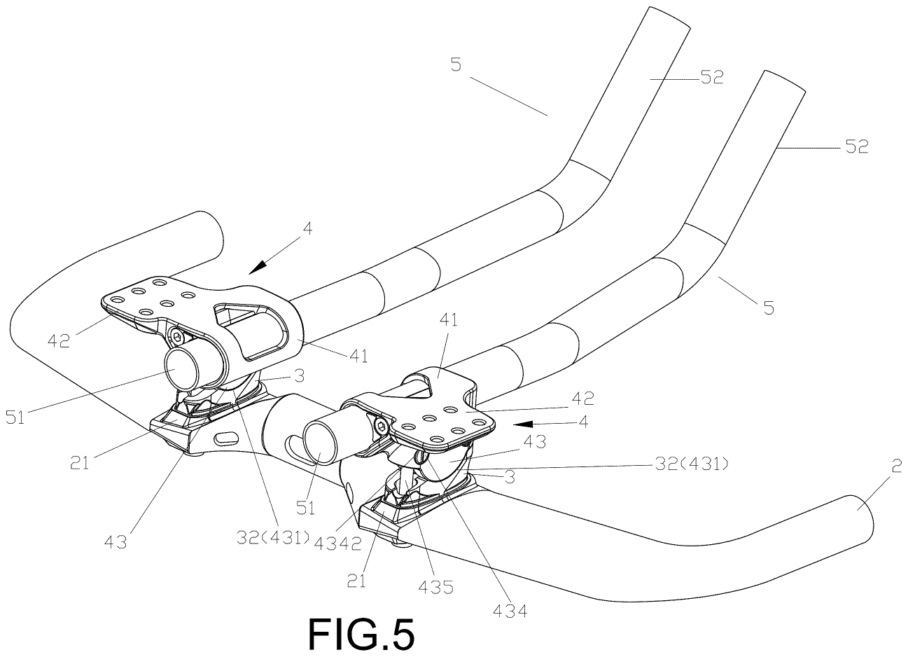

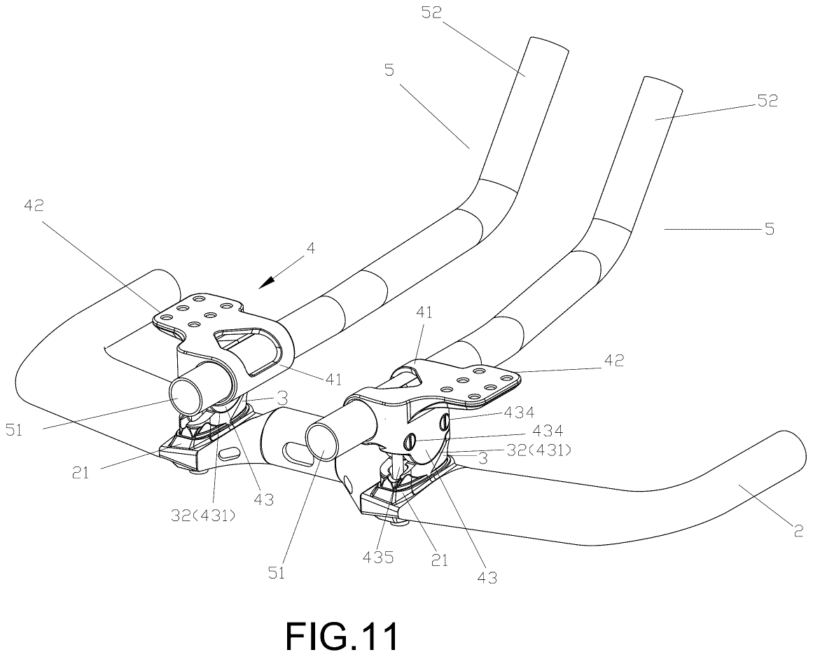

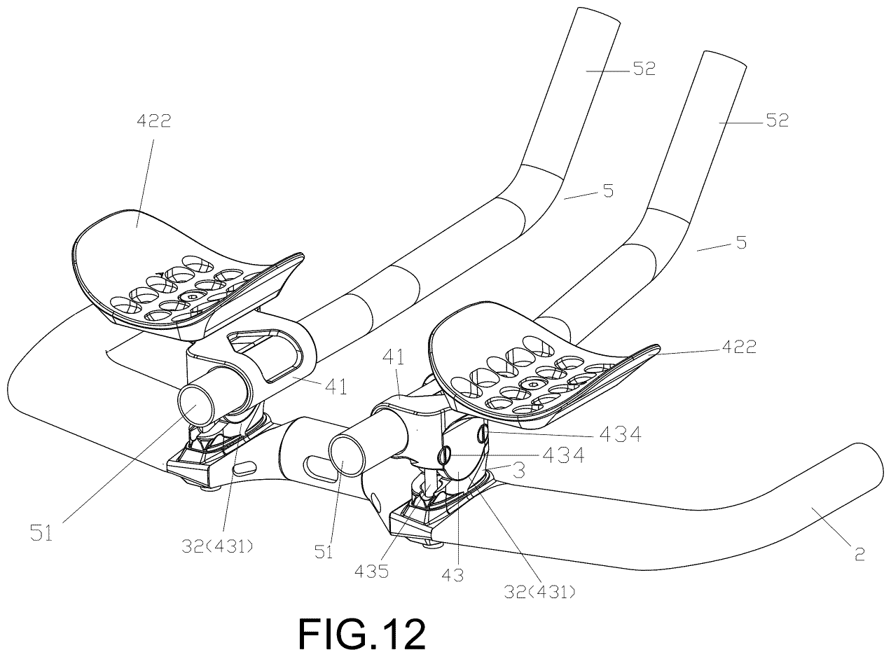

Please refer to FIG. 1 through FIG. 6 as well as FIG. 11 through FIG. 16. As shown in FIG. 11 through FIG. 16, a bicycle handlebar assembly according to a second embodiment of the present invention comprises a handlebar 2, two bases 3, two brackets 4, and two auxiliary handlebars 5. The second embodiment is substantially similar to the first embodiment with the exceptions described hereinafter. The top of the base 3 has an arc-shaped concave portion 32 with a constant curvature. The underside of the adjustment seat 43 of the bracket 4 has an arc-shaped convex portion 431 with a constant curvature. The extension seat 42 of the bracket 4 extends outward and rearward from the outer side of the sleeve section 41. The two auxiliary handlebars 5 are secured to the two brackets 4, respectively. When the brackets 4 are to be combined with the bases 3, the bracket 4 which is originally located close to the left side of the center of the handlebar 2 in the first embodiment is rotated 180 degrees clockwise to mate with the base 3 which is originally located close to the right side of the center of the handlebar 2 in the first embodiment, and the bracket 4 which is originally located close to the right side of the center of the handlebar 2 in the first embodiment is rotated 180 degrees counterclockwise to mate with the base 3 which is originally located close to the left side of the center of the handlebar 2 in the first embodiment, referring to FIG. 5 and FIG. 11. Finally, the two angle adjustment bolts 435 are inserted from the bottom ends of the apertures 211 of the positioning seat 21 on the handlebar 2 through the through holes 31 of the corresponding base 3 into the elongate grooves 432 in the adjustment seat 43 of the corresponding bracket 4 and locked with the locking holes 4341 of the two locking pins 434, such that the bracket 4 and the base 3 is mounted to the positioning seat 21 of the handlebar 2. Even when the two brackets 4 are rotated 180 degrees clockwise and counterclockwise respectively and swapped left and right, the armrests 422 can still be locked onto the tops of the extension seats 42 of the brackets 4. The rear ends 51 of the auxiliary handlebars 5 pass through the receiving holes 411 of the sleeve sections 41 of the brackets 4 and are secured to the brackets 4, respectively.

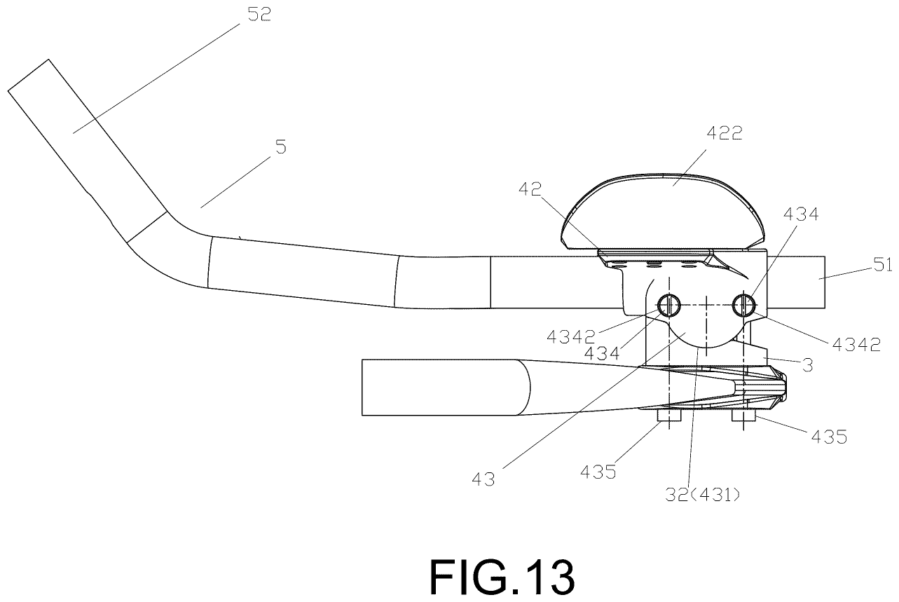

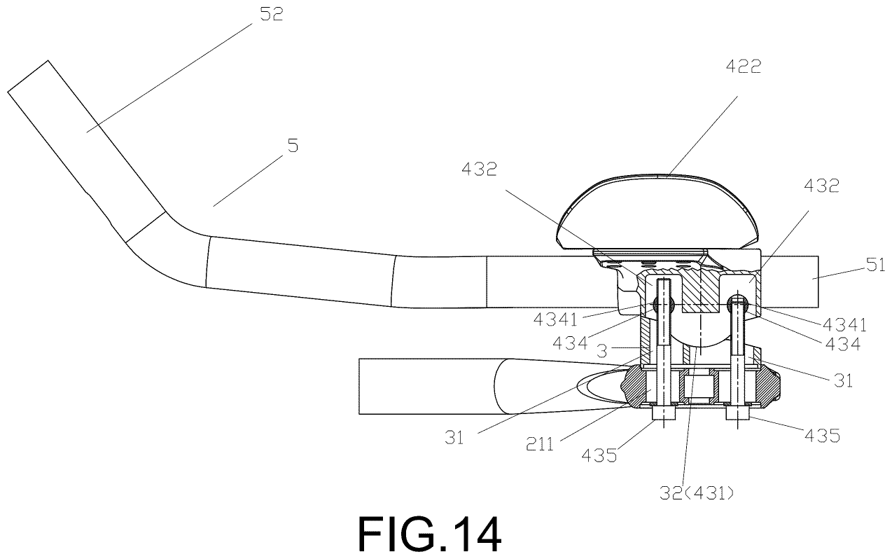

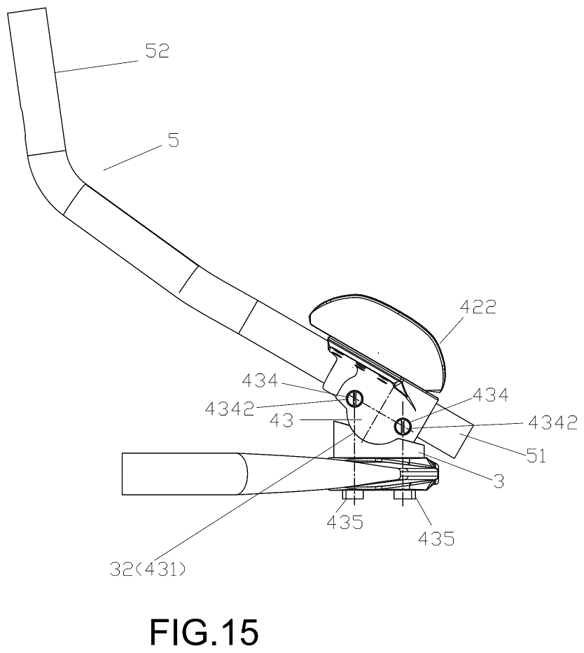

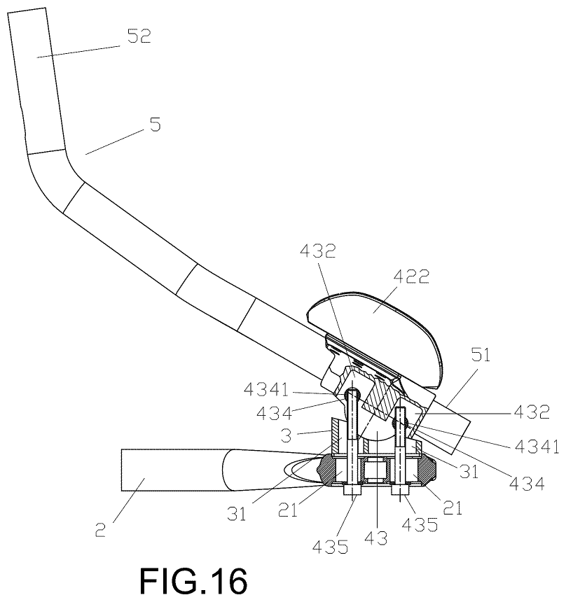

Through the aforementioned structural configuration, the auxiliary handlebar 5 can be adjusted in angle. Please refer to FIG. 13 and FIG. 14. Taking the auxiliary handlebar 5 initially assembled in a horizontal state as an example, the two angle adjustment bolts 435 are parallel to each other, in cooperation with the two locking pins 434 that are embedded and positioned in the two accommodating holes 433 of the adjustment seat 43. When the locking holes 4341 of the two locking pins 434 are engaged with the two angle adjustment bolts 435, the two locking pins 434 are in a horizontal state. As shown in FIG. 15 and FIG. 16, for the auxiliary handlebar 5 to be adjusted to tilt upward, the rear angle adjustment bolt 435 is further screwed and tightened along the locking hole 4341 of the rear locking pin 434, and the front angle adjustment bolt 435 is unscrewed and loosened. Thus, one of the locking pins 434 is moved upward and the other one of the locking pins 434 is moved downward, driving the bracket 4 to tilt upward and allowing the auxiliary handlebar 5 attached to the bracket 4 to be adjusted to tilt upward. For the auxiliary handlebar 5 to be adjusted to tilt downward, the rear angle adjustment bolt 435 is unscrewed and loosened along the locking hole 4341 of the rear locking pin 434, and the front angle adjustment bolt 435 is further screwed and tightened. Thus, one of the locking pins 434 is moved upward and the other one of the locking pins 434 is moved downward, driving the bracket 4 to tilt downward and allowing the auxiliary handlebar 5 attached to the bracket 4 to be adjusted to tilt downward. In this way, the auxiliary handlebar 5 can be adjusted in angle.

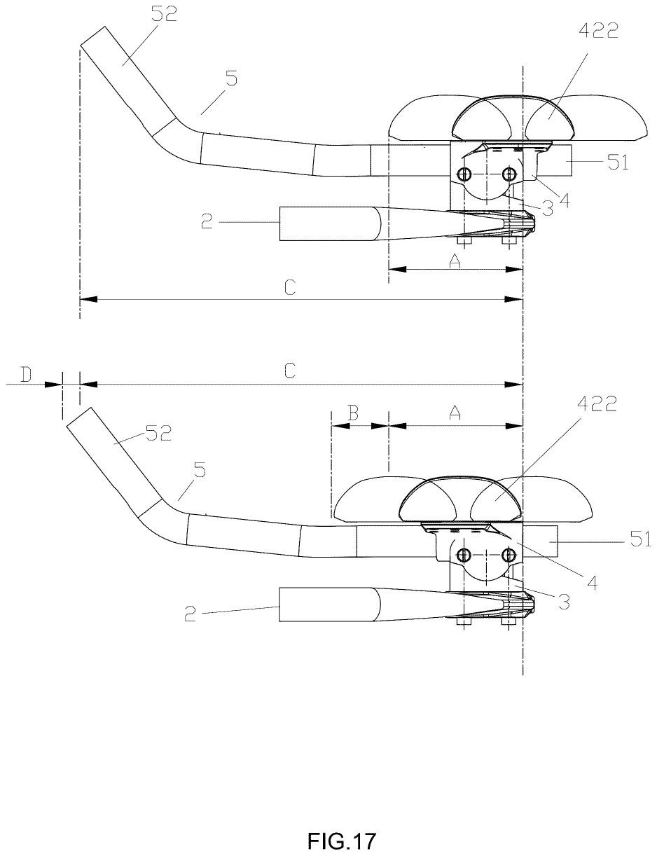

Furthermore, FIG. 17 is a comparative diagram of FIG. 7 and FIG. 13, viewed from the rear end of the base 3 secured to the handlebar 2 as the reference point. Even when the two brackets 4 are rotated 180 degrees clockwise and counterclockwise respectively and swapped left and right, the armrests 422 can still be locked onto the tops of the extension seats 42 of the brackets 4. The rear ends 51 of the auxiliary handlebars 5 pass through the receiving holes 411 of the sleeve sections 41 of the brackets 4 and are secured to the brackets 4, respectively. The armrest 422 is secured to the top of the extension seat 42 by the bolts 423 passing through the coupling holes 4221 of the armrest 422 and the mounting holes 421 of the extension seat 42. When the armrest 422 is to be moved and adjusted forward and rearward as well as left and right on the top of the extension seat 42, the distance by which the armrest 422 is adjusted toward the front end 52 of the auxiliary handlebar 5 can be increased by an additional distance B compared to the distance A in the first embodiment, thereby allowing the armrest 422 to be positioned closer to the front end 52 of the auxiliary handlebar 5. Similarly, the distance from the rear end 51 of the auxiliary handlebar 5 to the front end 52, measured with the rear end of the base 3 secured to the handlebar 2 as the reference point, can be increased by an additional distance D compared to the distance C in the first embodiment. When the cyclist leans forward to reduce wind resistance, as desired or necessary, the additional distance D allows the cyclist to grip the auxiliary handlebars 5 closer to the front ends 52 of the auxiliary handlebars 5. Accordingly, the bicycle handlebar assembly provided by the present invention allows cyclists to adjust the distance between the armrest 422 and the front end 52 of the auxiliary handlebar 5 based on the length of their arms and their preferred way of resting their arms on the armrests.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bicycle handlebar assembly, comprising a handlebar, two bases, two brackets, and two auxiliary handlebars;
the handlebar having two positioning seats located close to left and right sides of a center of the handlebar, each of the positioning seats having two apertures arranged in tandem;
the two bases being mounted on top of the respective positioning seats of the handlebar, each of the bases having two through holes arranged in tandem and corresponding in position to the apertures of corresponding the positioning seat and an arc-shaped concave portion with a constant curvature on a top thereof;
the two brackets each including a sleeve section, an extension seat, and an adjustment seat; the sleeve section having a receiving hole extending axially; the extension seat extending from an outer side of the sleeve section, an armrest being disposed on a top of the extension seat; the adjustment seat extending downward and being located between the sleeve section and the extension seat, an underside of the adjustment seat having an arc-shaped convex portion with a constant curvature to mate with the arc-shaped concave portion of the top of the base, a lower section of the adjustment seat having two elongate grooves arranged in tandem and corresponding in position to the two through holes of the base, one side of the adjustment seat having two accommodating holes communicating with the respective elongate grooves for accommodating two locking pins each having a locking hole, two angle adjustment bolts being inserted from bottom ends of the apertures of the positioning seat of the handlebar through the through holes of the corresponding base into the elongate grooves in the adjustment seat of the corresponding bracket and locked with the locking holes of the two locking pins;
the two auxiliary handlebars each having a rear end and a front end extending upward at an angle, the rear end passing through the receiving hole of the sleeve section of the corresponding bracket and being secured to the corresponding bracket.

2. The bicycle handlebar assembly as claimed in claim 1, wherein the extension seat of the bracket extends outward and rearward from the outer side of the sleeve section.

3. The bicycle handlebar assembly as claimed in claim 1, wherein the base is generally trapezoidal in shape.

4. The bicycle handlebar assembly as claimed in claim 1, wherein each of the locking pins is sleeved with an elastic washer located around a periphery of the corresponding accommodating hole.

5. The bicycle handlebar assembly as claimed in claim 1, wherein the extension seat of the bracket has a plurality of mounting holes arranged in parallel, the armrest has a plurality of coupling holes arranged in parallel, the coupling holes of the armrest correspond to the mounting holes of the extension seat, and the armrest is secured on the top of the extension seat by bolts passing through the coupling holes and the mounting holes.

6. The bicycle handlebar assembly as claimed in claim 5, wherein by aligning the coupling holes of the armrest with the mounting holes of the extension seat at different positions, the armrest is movable and adjustable forward and rearward as well as left and right on the top of the extension seat and locked by the bolts.
